(19) United States
(12) Patent Application Publication
(10) Pub. No.: US 2026/0170112 A1
(43) Pub. Date: Jun. 18, 2026

(54) MOBILE DEVICE SNATCH DETECTION AND SECURITY

(71) Applicant: Motorola Mobility LLC, Chicago, IL (US)

(72) Inventors: Jenna M. Zylema, Chicago, IL (US); Ranjeet Gupta, Plainfield, IL (US); Eric J. Hefner, Lombard, IL (US)

(73) Assignee: Motorola Mobility LLC, Chicago, IL (US)

(21) Appl. No.: 18/979,793

(22) Filed: Dec. 13, 2024

(51) Int. Cl. G06F 21/32; H04M 1/72454

(52) U.S. Cl. CPC G06F 21/32; H04M 1/72454

(57) ABSTRACT

Techniques for mobile device snatch detection and security are described and are implementable to prevent false positive snatch event detections from interrupting a user experience. In implementations, a mobile device detects a snatch event indicative of the mobile device being physically taken from a user when the mobile device is in an unlocked state. The mobile device automatically attempts a biometric authentication of the user to validate the snatch event. Responsive to a failed biometric authentication, the mobile device transitions to a locked state, and responsive to a successful biometric authentication, the mobile device refrains from transitioning to the locked state.

### BACKGROUND

Modern mobile devices are targets for snatch-and-grab thefts due to their prevalence and high value. Some phone manufacturers attempt to implement snatch event detectors to detect possible snatch events and perform actions in response to possible snatch events. Conventional snatch event detectors, however, experience high false positive rates due to variability in the ways snatch events can occur. User actions may be mistaken for snatch attempts, resulting in unnecessary device lockouts and interruption of user experiences. Out of frustration, mobile device users frequently disable snatch event-related security features to improve usability.

### BRIEF DESCRIPTION OF THE DRAWINGS

Aspects of mobile device snatch detection and security are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of mobile device snatch detection and security can be implemented in accordance with one or more implementations.

FIG. 2 depicts a block diagram of an example system that can be implemented for mobile device snatch detection and security in accordance with one or more implementations.

FIG. 3 illustrates a flow chart depicting an example method for mobile device snatch detection and security in accordance with one or more implementations.

FIG. 4 illustrates a flow chart depicting another example method for mobile device snatch detection and security in accordance with one or more implementations.

FIG. 5 illustrates a flow chart depicting another example method for mobile device snatch detection and security in accordance with one or more implementations.

FIG. 6 illustrates various components of an example device in which aspects of mobile device snatch detection and security can be implemented in accordance with one or more implementations.

### DETAILED DESCRIPTION

Techniques for mobile device snatch detection and security are described and are implementable to prevent false positive snatch event detections from interrupting a user experience. Conventional motion algorithms and machine-learning models may be unreliable in detecting each of the various ways that snatch events can occur. User actions, such as device motion-based gestures, drops, and falls, may be mistaken for attempts to take the device from the user’s possession. For example, conventional snatch event detectors are preprogrammed or trained to trigger snatch events based on similar sensor data (e.g., accelerometer and gyroscope movements) expected for receiving device gestures that facilitate rapid access to device applications. In case of conflicts, snatch event detections may be prioritized over device gesture detections and without regard to other sensor-based activities, which may be referred to throughout as various types of application activities (e.g., motion controls for games and augmented or virtual reality simulations), which can cause unnecessary device locks and poor user experiences. Disabling an unreliable snatch event detector to improve usability and device functionality may cause the mobile device to be less secure.

In at least one implementation, a mobile device, such as a mobile phone or tablet device, includes at least one processor configured to implement a snatch event validator, which verifies through biometric authentication of the user whether to trust a reported snatch event. The snatch event validator allows a snatch event detector to be executed on the mobile device to trigger a security countermeasure (e.g., an automatic device lock function) when biometric authentication fails. The reported snatch event may be ignored when the biometric authentication succeeds.

Imagine a user holding a mobile device in a public space. The user unlocks the mobile device, and an application presents a user interface that is configured to receive user inputs to enable a user experience. For example, the user is conducting a video call with a friend. Before long, the user may become lost in the user experience (e.g., the video call) and not notice changes in the surrounding environment, such as other people moving in and out of the public space.

Now picture the user gets excited while talking to the friend and accidentally drops the mobile device on the ground. As the device is falling, one or more sensors of the mobile device record sensor data describing a sudden change in one or more of device acceleration, rate of rotation, and elevation. The snatch event detector processes the sensor data and falsely registers the fall event as a snatch event indicative of the mobile device being physically taken from the user.

The mobile device is configured to automatically lock the user interface in response to the detected snatch event. However, because the snatch event detector is not always reliable, the snatch event is validated prior to activating a security measure. The snatch event validator triggers a biometric authentication of the user to determine whether to trust the detected snatch event. In at least one example, the biometric authentication is a face authentication that verifies a user identity based on facial recognition. Other forms of biometric authentication may be used, such as an iris scan authentication that relies on scans of a user’s eyes.

The result of the biometric authentication may enable the snatch event validator to determine whether the mobile device remains in possession of the user or is actually being stolen. For example, a face authentication is executed as the user is bending down to pick up the dropped device. Responsive to a successful face authentication, the reported snatch event may be ignored or discarded as the mobile device is kept in the unlocked state. The user is able to return to the video call, which remains active throughout the drop.

Consider another situation where the mobile device is being snatched from the user. For example, a thief approaches the user from behind and forcefully yanks the mobile device from the user’s hand. As the device is being snatched from the user, the sensors of the mobile device record sensor data, which again describes a sudden change in one or more of device acceleration, rate of rotation, and elevation. The snatch event detector processes the sensor data and correctly reports another snatch event indicative of the mobile device being physically taken from the user.

This time, when the snatch event validator triggers the biometric authentication of the user to determine whether to trust the detected snatch event, the biometric authentication fails. For example, the face authentication or iris scan authentication is unable to authenticate the user because the mobile device is being carried away in the hands of the thief. The failed biometric authentication causes the snatch event validator to activate the security measure and transition the mobile device to a locked state, which prevents the device from being used until a subsequent biometric authentication succeeds.

In one or more implementations, the snatch event validator further enhances the reliability experienced with the snatch event detector by deferring or delaying the biometric authentications performed to validate snatch events. For example, the sensor data processed by the snatch event detector is also analyzed by an application for implementing a sensor-based activity (also referred to throughout as an application activity) that uses or is triggered by the sensor data also being used to detect the snatch event. The sensor-based activity, for instance, maps sensor readings obtained from an accelerometer, a gyroscope, a barometer, or other sensor of the mobile device to one or more motion gestures (e.g., device shake, device chop, device tap) corresponding to user inputs. The output of the snatch event detector may conflict with the sensor-based activity, which recognizes gestures from the same sensor data that caused the erroneous detection of a snatch event.

When the snatch event validator determines that an application activity is also using or is triggered by another application or system activity analyzing the sensor data evaluated by the snatch event detector, a biometric authentication of the user to validate the snatch event is automatically attempted after execution of the application activity has stopped or paused. For example, when the sensor-based activity is stopped or paused, the snatch event validator triggers the biometric authentication to validate or invalidate the output from the snatch event detector. As used herein, the term “sensor-based activity” includes operations performed by an application in response to the application processing the sensor data directly, as well as operations performed by other applications or system services that process the sensor data on behalf of the application to trigger the sensor-based activity. For example, when a user of the mobile device launches a camera application by performing a double-twist device motion gesture, the camera application may not process accelerometer or gyroscope data directly to detect the double-twist-device motion gesture. However, when a system service or other application configured to process the sensor data directly infers the double twist device motion gesture, a viewfinder of the camera application is launched as a foreground task for taking pictures. The camera application and the viewfinder may not be directly using or processing the relevant accelerometer and gyroscope data. However, the camera application and the viewfinder are sensor-based activities nonetheless, which are executed downstream from an algorithm or other process performed in the execution environment of the mobile device that directly monitors the sensor data. Delaying the biometric authentications performed to validate snatch events furthers an ongoing user experience with application activities that process sensor data or are triggered by other activities that process the sensor data without diminishing security.

The snatch event validator is designed to prevent false positive snatch events from causing unnecessary device locks while still allowing the mobile device to automatically lock during actual snatch events. This enhances user satisfaction by ensuring that user actions are not mistakenly identified as snatch events. The validator discards false positive detections to avoid unnecessary device locks without disabling the snatch event detector, thereby maintaining the security of the mobile device in the event the mobile device is actually stolen.

While features and concepts of mobile device snatch detection and security can be implemented in any number of environments and/or configurations, aspects of the techniques are described in the context of the following example systems, devices, and methods. Further, the systems, devices, and methods described herein are interchangeable in various ways to provide for a wide variety of implementations and operational scenarios.

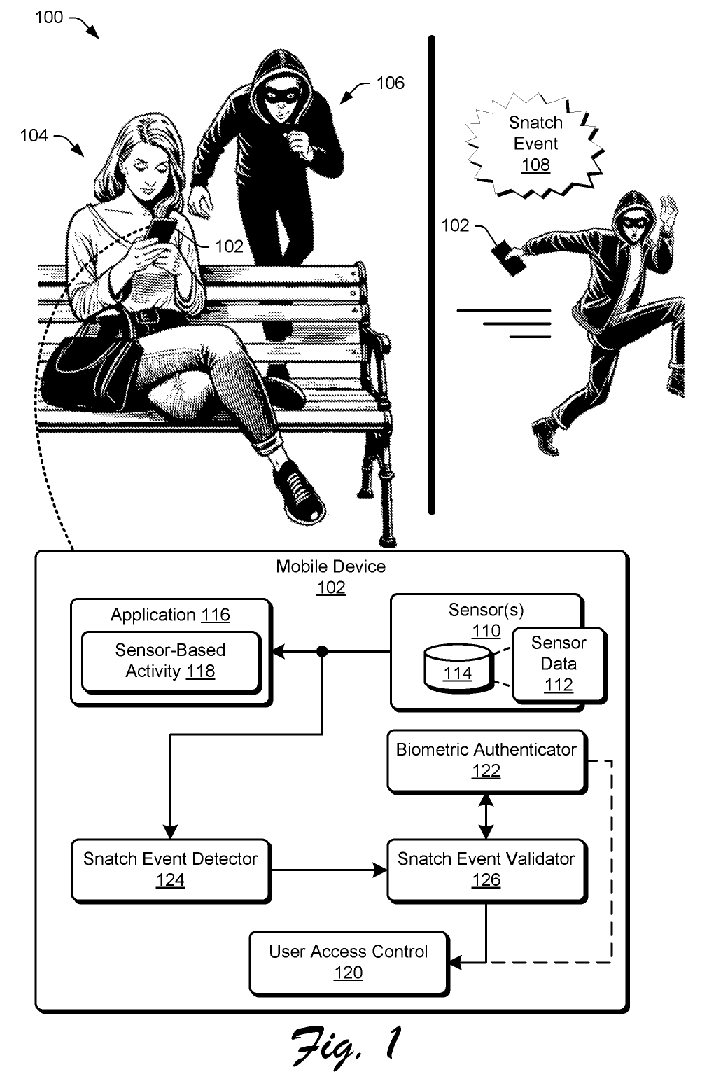

FIG. 1 illustrates an example environment 100 in which aspects of mobile device snatch detection and security can be implemented in accordance with one or more implementations. The environment 100 includes a mobile device 102 in possession of a user 104, who is sitting on a bench. A thief 106, intent on snatching the mobile device 102, approaches the user 104 from behind. A snatch event 108 occurs when the thief 106 suddenly grabs the mobile device 102 out of the hands of the user 104 and flees the environment 100.

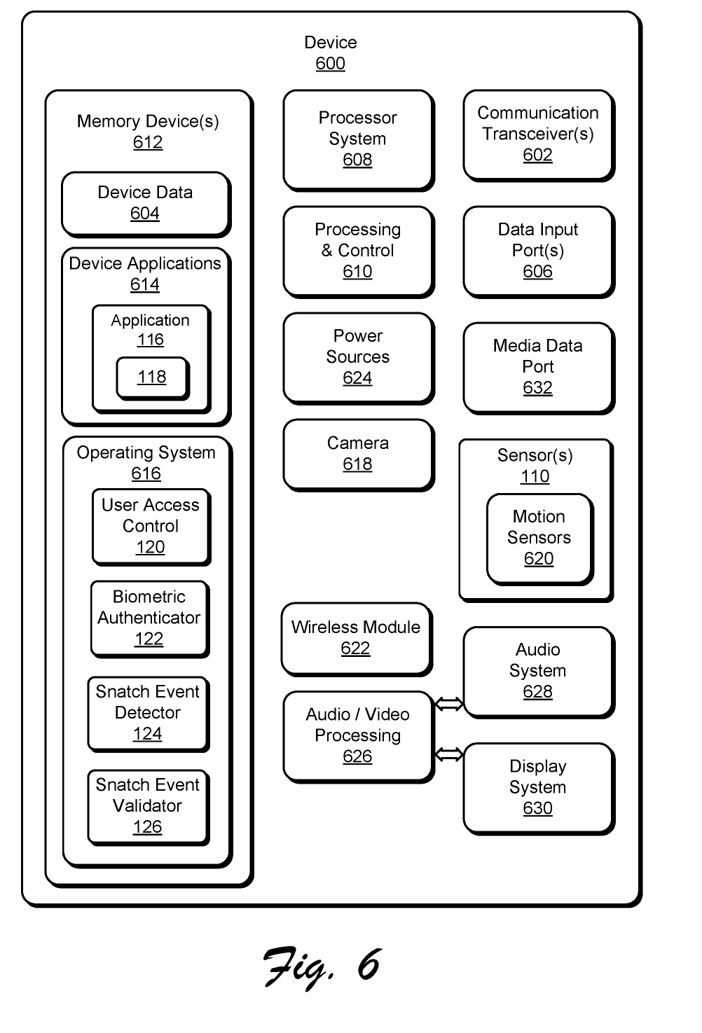

The mobile device 102 represents any portable device, such as a mobile phone, a tablet device, a laptop computer, a wearable device, and so forth, which, when possessed by the user 104, is at risk of being taken or snatched. The mobile device 102 can represent any type of electronic and/or computing device implemented with various components, such as a processor system and memory, as well as any number and combination of different components as further described with reference to the example device 600 shown in FIG. 6.

The mobile device 102 includes one or more sensors 110 configured to generate sensor data 112. The sensor data 112 includes information that describes a device state or the context of the mobile device 102. For example, the sensor data 112 includes information used to determine whether or not the mobile device 102 is in the hands of the user 104. Some non-limiting examples of the sensors 110 include an accelerometer, a gyroscope, a barometer, a proximity sensor, a position or location sensor, an ambient light sensor, a magnetometer, a camera, or another type of sensor capable of detecting movement, orientation, placement, or other indication of the state or context of the mobile device 102. When used in combination, the sensors 110 improve device functionality, security, and responsiveness.

A memory 114 of the mobile device 102 is configured to maintain the sensor data 112 generated using the sensors 110. The sensor data 112 is accessible from the memory 114 to implement various sensor-based functions or sensor-based activities executed by the mobile device 102. An application 116, for instance, is shown executing on the mobile device 102.

The application 116 executes an application activity, which is labeled in FIG. 1 and referred to throughout as a sensor-based activity 118 that can take various forms and serve a variety of purposes. As one example, the application 116 is a fitness tracker, and the sensor-based activity 118 directly uses accelerometer and gyroscope measurements acquired from the sensor data 112 to track the steps of the user 104, monitor a workout, and measure physical activity. As another example, the application 116 is a music application and the sensor-based activity 118 is a music playback activity that indirectly uses the sensor data 112 to enable music playback controls (e.g., skip to a next song in response to a shake device motion gesture). An application framework, an operating system, or other application or service executed by the mobile device 102 may monitor the sensor data 112 on behalf of the application 116 to trigger the sensor-based activity 118 with or without analyzing the sensor data 112 directly. The application 116 may be a navigation application that uses a combination of accelerometer, magnetometer, barometer, and position or location information obtained from the sensor data 112 to navigate, including indoors (e.g., in a shopping center, in a parking garage, in an airport). Other examples of the application 116 include a game, an augmented reality simulator, and a system service. For example, the application 116 is a system application and implements a flashlight function as the sensor-based activity 118 that is triggered by sensor data 112 and does not process the sensor data 112 directly. When a different application (e.g., a device motion gesture detector) correlates movement indicated by the sensor data 112 to a quick launch gesture mapped to the flashlight function, the sensor-based activity 118 of the application 116 is triggered and reconfigures a camera flash of the mobile device 102 to operate a flashlight. As part of a game, the sensor-based activity 118 may use parts of the sensor data 112 captured with a gyroscope and an accelerometer to enable interactive and immersive motion-based game controls. An augmented reality simulator may provide a more realistic user experience using the sensor data 112 to track device orientation and movement.

With the application 116 implementing a system service, the sensor-based activity 118 may enable device gesture recognition based on the sensor data 112. For example, different types of device gestures are mapped to different system functions. The application 116 outputs an indication of a type of device gesture detected by the sensor-based activity 118, such as a device shake gesture (e.g., the user 104 shakes the mobile device 102 back and forth), a device chop gesture (e.g., the user 104 quickly moves the mobile device 102 up and down), a device twist gesture (e.g., the user 104 rotates the mobile device 102 about one or more axis), a device lift gesture (e.g., the user 104 picks up the mobile device 102), or a device flip gesture (e.g., the user 104 turns the mobile device 102 over). In this example, the sensor-based activity 118 is configured as a device motion gesture detector that directly processes the sensor data 112 to detect and enable the application 116 or other entities executing on the mobile device 102 to respond to these user gesture events inferred from the sensor data 112.

As depicted in FIG. 1, the mobile device 102 also includes a user access control 120. The user access control 120 ensures security and privacy by managing a locking and unlocking function of the mobile device 102. For example, the user access control 120 manages an authentication user interface that enables the user 104 to set up pins, patterns, and passwords as basic forms of security. The user access control 120 is configured to receive signals from other components on the mobile device 102 to invoke the locking or unlocking functions managed by the user access control 120. For example, the user access control 120 locks the mobile device 102 in response to receiving a time-out signal from a timer of a system service that monitors for inactivity. The user access control 120 helps protect sensitive data maintained on the mobile device 102 from unauthorized access while providing a seamless user experience for the user 104. In some examples, the user access control 120 interacts with a biometric authenticator 122 of the mobile device 102 to further enhance security and usability.

The biometric authenticator 122 supports the user access control 120 and other functions of the mobile device 102 to maintain security while supporting convenient access to the mobile device 102. The biometric authenticator 122 can include one or multiple different types of biometric authentication systems.

As one example, the biometric authenticator 122 includes a fingerprint detector that verifies the identity of the user 104 based on a fingerprint scan. Fingerprint sensors may be embedded in the housing of the mobile device 102, a physical button or switch of the mobile device 102, under a display or touchscreen of the mobile device 102, or another part of the mobile device 102 that allows the user 104 an intuitive and simple feature for unlocking the mobile device 102 with a simple touch.

The biometric authenticator 122 may include a voice authenticator that compares a voice signal captured by a microphone of the mobile device 102 to a voiceprint of the user 104. The voice authenticator implements voiceprint recognition techniques to analyze unique characteristics of the voice of the user 104, enabling access to the mobile device 102 when the voice of the user 104 is detected.

As another example, the biometric authenticator 122 includes a face authentication system. The face authentication system may utilize a camera of the mobile device 102 to map and later recognize unique facial features of the user 104, and enables hands-free unlocking, electronic payment authorization, or secure access to other functionality of the mobile device 102.

The biometric authenticator 122 may include iris scan authentication system. For example, an iris scan authentication system projects infrared light towards a user face to scan the unique and intricate iris patterns of the eyes of the user 104 to verify user identity and unlock the mobile device 102 or implement other functionality of the mobile device 102.

A snatch event detector 124 is implemented on the mobile device 102 to detect the snatch event 108 that causes the mobile device 102 to implement a security action, such as transitioning the mobile device 102 to a locked state. For example, the snatch event 108 is detected when the mobile device 102 is being physically taken from the user 104, in particular, when the mobile device 102 is in an unlocked state and sensitive information maintained on the mobile device 102 is accessible to the thief 106. A snatch event flag may be set by the snatch event detector 124 in response to the snatch event 108.

A snatch event validator 126 is implemented on the mobile device 102 to backstop and improve the reliability of the snatch event detector 124. The snatch event validator 126 identifies and prevents erroneous snatch events reported from the snatch event detector 124 from causing the security action on the mobile device 102 (e.g., unnecessarily transitioning the mobile device 102 to a locked state). For example, the snatch event flag set by the snatch event detector 124 is either maintained or cleared based on whether the snatch event validator 126 can verify the snatch event 108. The snatch event 108 may be verified through the biometric authenticator 122 by allowing the snatch event 108 detected to trigger a security countermeasure when the biometric authentication fails and ignoring or discarding the snatch event 108 (e.g., clearing the snatch event flag) when the biometric authentication is successful.

As depicted in FIG. 1, the user 104 is sitting on a park bench while holding the mobile device 102 to view content presented on a display screen. The thief 106 approaches the user 104 from behind, forcefully yanks the mobile device 102 away from the user 104, and flees the environment 100. As the mobile device 102 is being snatched from the user 104, the sensors 110 record the sensor data 112.

During the snatch event 108, the sensor data 112 describes a sudden change in movement, position, or orientation of the mobile device 102. For example, an indication of the snatch event 108 is output when specific patterns in the sensor data 112 (e.g., one or more of device acceleration, rate of rotation, and elevation) are observed by the snatch event detector 124. The mobile device 102 is configured to automatically lock the mobile device 102 in response to the detected snatch event 108. For example, the user access control 120 locks the mobile device 102 based on the snatch event flag being set.

Due to a possibility of false positive snatch event detections being reported from the snatch event detector 124, the indication of the snatch event 108 is validated prior to allowing the user access control 120 to activate a security measure based on the state of the snatch event flag.The snatch event validator 126 triggers the biometric authenticator 122 to perform a biometric authentication of the user 104 and determine whether to trust the indication of the snatch event 108. For example, the biometric authenticator 122 attempts a face authentication to verify the identity of the user 104 based on facial recognition or an iris scan authentication that relies on iris scans of the eyes of the user 104.

In this example, the snatch event 108 is valid based on the mobile device 102 changing hands and being in possession of the thief 106. As such, the biometric authentication performed by the biometric authenticator 122 fails to verify the identity of the user 104. The failed biometric authentication reported by the biometric authenticator 122 causes the snatch event validator 126 to maintain the snatch event flag and communicate with the user access control 120 to activate a security measure. The user access control 120 transitions the mobile device 102 to a locked state, which prevents the mobile device 102 from being used until a subsequent biometric authentication succeeds.

Besides snatch events, other types of device events are discernable from analyzing patterns in the sensor data 112 collected by the sensors 110. For example, device gestures and device drops or falls have specific acceleration, rate of rotation, or elevation changes that may be similar to the acceleration, rate of rotation, or elevation changes observed by the sensors 110 during the snatch event 108. The snatch event detector 124 is susceptible to falsely registering these other events as the snatch event 108.

A result of a biometric authentication executed by the biometric authenticator 122 enables the snatch event validator 126 to clear or discard false indications of snatch events based on whether the mobile device 102 remains in possession of the user 104 at around the time the snatch event 108 is reported. For example, if the mobile device 102 is dropped rather than snatched, a face authentication invoked by the snatch event validator 126 (e.g., as the user 104 is bending down to pick the mobile device 102 up off the ground) is successful. Responsive to the successful face authentication, the snatch event validator 126 causes the reported snatch event to be ignored or discarded. The snatch event validator 126, for instance, clears the snatch event flag to maintain the mobile device 102 in the unlocked state. The user access control 120 refrains from implementing a security measure, and the user 104 is able to enjoy use of the mobile device 102, which remains unlocked as the user 104 picks up the mobile device 102 after the drop.

In one or more implementations, the snatch event validator 126 further enhances reliability experienced with the snatch event detector 124 by deferring or delaying the biometric authentications performed to validate snatch events when the sensor-based activity 118 is relying on the sensor data 112 when the snatch event 108 is detected. For example, the sensor data 112 processed by the snatch event detector 124 is also analyzed by the application 116 for implementing the sensor-based activity 118. The sensor-based activity 118, for instance, compares the sensor data 112 to reference patterns used to discern one or more motion gestures (e.g., device shake, device chop, device tap) corresponding to user inputs. The output of the snatch event detector 124 may conflict with the sensor-based activity 118, which recognizes gestures from the same sensor data 112 that causes the snatch event detector 124 to output an erroneous detection of the snatch event 108.

When the snatch event validator 126 determines that an application activity is also using or is triggered by a downstream application or system service using the sensor data 112 evaluated by the snatch event detector 124, a biometric authentication of the user 104 to validate the snatch event 108 is deferred, and automatically attempted after execution of the application activity has stopped or paused. For example, when the application 116 and the sensor-based activity 118 move to a background task or are stopped or paused, the snatch event validator 126 triggers the biometric authenticator 122 to verify user identity and validate or invalidate the output from the snatch event detector 124. Delaying the biometric authentications performed to validate snatch events furthers an ongoing user experience of the mobile device 102. For example, first sensor-based activities are allowed to continue to process the sensor data 112 directly, and second sensor-based activities are able to respond indirectly to the sensor data 112 by the first sensor-based activities without diminishing security.

The snatch event validator 126 prevent false positive snatch events from causing unnecessary device locks while still allowing the mobile device 102 to automatically lock during actual snatch events. This enhances satisfaction of the user 104 by ensuring that user actions are not mistakenly identified as snatch events. The snatch event validator 126 discards false positive detections to avoid unnecessary device locks without disabling the snatch event detector 124, thereby maintaining the security of the mobile device 102 in the event the mobile device 102 is actually stolen.

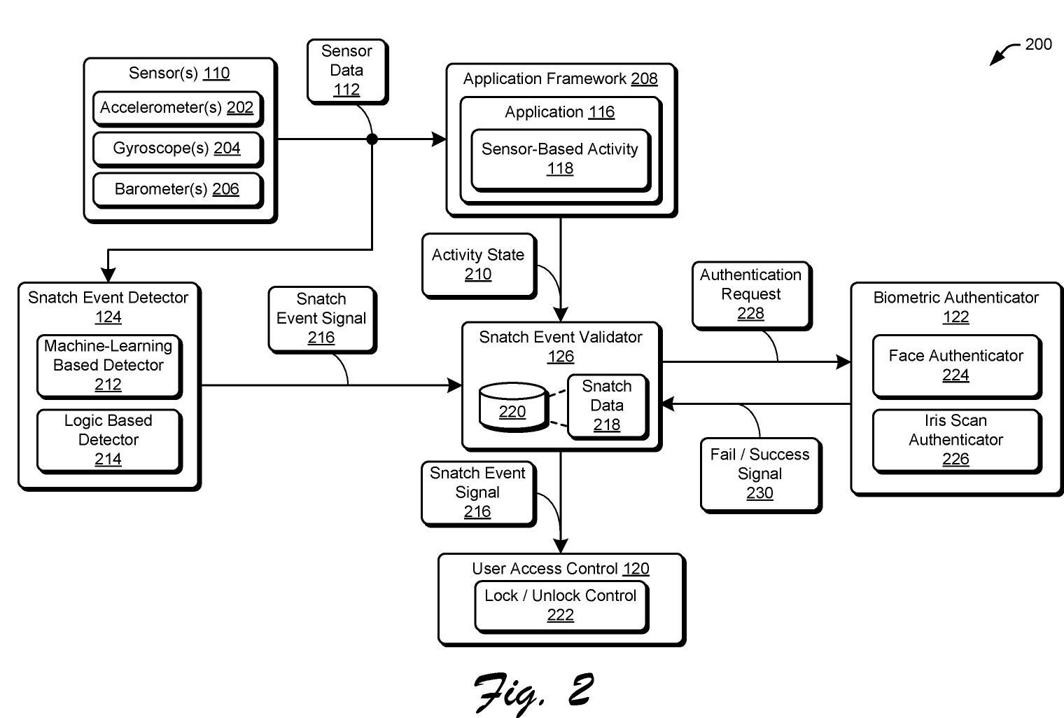

FIG. 2 depicts a block diagram of an example system 200 that can be implemented for mobile device snatch detection and security in accordance with one or more implementations. For example, the system 200 is described in the context of the environment 100 and being implemented on the mobile device 102 using similarly labeled elements as FIG. 1. The system 200 is implemented using a processing system (e.g., at least one processor) and a memory system configured to execute instructions to implement one or more of the application 116, the user access control 120, the biometric authenticator 122, the snatch event detector 124, the snatch event validator 126, and components thereof.

In at least one implementation, the application 116, the user access control 120, the biometric authenticator 122, the snatch event detector 124, and the snatch event validator 126 are implemented at least partially as a module that includes independent processing, memory, and/or logic components functioning as a computing and/or electronic device integrated with the mobile device. One or more of the application 116, the user access control 120, the biometric authenticator 122, the snatch event detector 124, and the snatch event validator 126 may include one or more modules, which are executed in an application execution environment of the mobile device 102 (e.g., an operating system executed by a central processing unit or CPU of the mobile device 102). At least part of the application 116, the user access control 120, the biometric authenticator 122, the snatch event detector 124, the snatch event validator 126 may represent one or more programs, threads, services, or executables. Alternatively or in addition, at least part of the application 116, the user access control 120, the biometric authenticator 122, the snatch event detector 124, the snatch event validator 126, and components thereof, can be implemented as a software application or software module, such as integrated with the operating system running on the CPU, for instance, based on computer-executable instructions loaded in memory or storage of the mobile device 102.

As software applications or modules, the application 116, the user access control 120, the biometric authenticator 122, the snatch event detector 124, the snatch event validator 126, and supporting components of each may also be implemented as one or more artificial intelligence algorithms and/or machine learning algorithms. Alternatively or in addition, the application 116, the user access control 120, the biometric authenticator 122, the snatch event detector 124, the snatch event validator 126, and related parts of each may be implemented in firmware and/or at least partially in computer hardware. For example, at least part of the application 116, the user access control 120, the biometric authenticator 122, the snatch event detector 124, the snatch event validator 126 is executable as firmware, and another part is implemented by a software executable, and another part is implemented in logic or circuitry of the mobile device 102.

In the example depicted in FIG. 2, the sensors 110 include one or more accelerometers 202, one or more gyroscopes 204, and one or more barometers 206. The sensors 110 output sensor data 112. For example, the sensor data 112 includes accelerometer data obtained from the accelerometers 202. When the snatch event 108 is detected, for instance, the sensor data 112 indicates a sudden or abrupt change in acceleration of the mobile device 102. The sensor data 112 may include gyroscope data obtained from the gyroscopes 204. For example, when the snatch event 108 is detected, the sensor data 112 indicates a sudden or abrupt change in a rate of rotation of the mobile device 102. In one or more implementations, the sensor data 112 includes ambient air pressure data obtained from the barometers 206. If the snatch event 108 occurs, for instance, the sensor data 112 indicates a sudden or abrupt change in ambient air pressure measured by the mobile device 102. This sudden change in air pressure is correlated by the snatch event detector 124 to a sudden change in elevation of the mobile device 102.

The sensor data 112 is communicated as an input to the application 116, which is depicted executing within an application framework 208. The application framework 208 may be an operating system of the mobile device 102, an application container of the mobile device 102, or a guest operating system of the mobile device 102 that executes the application 116 within a virtual machine. The application framework 208 is configured to output an activity state 210 associated with the application 116 and the sensor-based activity 118. The activity state 210, for instance, indicates whether execution of the sensor-based activity 118 or the application 116 is paused or stopped. The application framework 208 is operable to cause the application 116 to execute as a background task when not being accessed from the mobile device 102, and in that case, the activity state 210 indicates the sensor-based activity 118 is stopped or paused. When the application framework 208 causes the application 116 to execute as a foreground task again, the activity state 210 indicates the sensor-based activity 118 is ongoing and using the sensor data 112.

The sensor data 112 is also communicated as an input to the snatch event detector 124 to detect the snatch event 108. In the depicted example of FIG. 2, the snatch event detector 124 includes a machine learning-based detector 212 and a logic based detector 214. In variations, the snatch event detector 124 includes the machine-learning based detector 212 and does not include the logic based detector 214. In other examples, the snatch event detector 124 includes the logic based detector 214 but not the machine-learning based detector 212. The snatch event detector 124 executes at least one of the machine-learning based detector 212 or the logic based detector 214 to generate a snatch event signal 216 as an indication of the snatch event 108 being detected from the sensor data 112.

The machine-learning based detector 212 implements a machine-learning model trained to detect the snatch event 108 based on sensor data 112 collected by one or more of the sensors 110 of the mobile device 102. The machine-learning model may be a neural network that is trained to recognize patterns in the sensor data 112 that correlate to patterns of sensor measurements input to the model during training. The snatch event signal 216 is output from the machine-learning based detector 212 when the machine-learning model has confidence that the sensor data 112 corresponds to the snatch event 108. For example, a score is determined for the snatch event signal 216 and the snatch event signal 216 is output in response to the model determining that the score satisfies a threshold (e.g., a minimum score).

The logic based detector 214 does not use machine-learning but instead implements a logical based function to discern the snatch event 108 from the sensor data 112. For example, the snatch event 108 is detected in response to the logic based detector 214 identifying a change in the sensor data 112 that satisfies a threshold for suspected snatch events. The threshold for suspected snatch events used by the logic based detector 214 may be different than at least one other threshold that is used to detect at least one of a drop event, a fall event, or a user gesture event, enabling the logic based detector 214 to discern between actual snatch events and other device actions, whether intentional or not intentional. In one or more examples, the threshold used by the logic based detector 214 for detecting suspected snatch events corresponds to at least one of a change in the acceleration of the mobile device 102, a change in the rate of rotation of the mobile device 102, or a change in the elevation of the mobile device 102.

The snatch event validator 126 intercepts snatch data 218 output from the snatch event detector 124 and stores the snatch data 218 in a memory 220 of the snatch event validator 126. For example, the snatch event signal 216 changes the state of a snatch event flag from indicating no snatch events to indicating the occurrence of the snatch event 108. An indication of the snatch event 108 conveyed by the snatch event signal 216 is flagged in the memory 220. Then, when the snatch event validator 126 validates the snatch event signal 216 to implement a security measure or refrain from implementing the security measure, the indication of the snatch event 108 is cleared. For example, the snatch event signal 216 is forwarded to the user access control 120 to trigger a lock / unlock control 222. The lock / unlock control 222 transitions the mobile device 102 into and out of a locked state. The mobile device 102 operates in an unlocked state while the user 104 interacts with the application 116, for instance, and then transitions to the locked state when the snatch event signal 216 is received by the lock / unlock control 222.

The biometric authenticator 122 is depicted in FIG. 2 as having multiple authentication functions, however, in at least one example, the biometric authenticator 122 includes a single authentication function. For example, the biometric authenticator 122 includes at least one of a face authenticator 224 or an iris scan authenticator 226. The biometric authenticator 122 is configured to receive an authentication request 228 and respond with a fail / success signal 230 output as an indication of whether a face authentication, an iris scan authentication, or other biometric authentication is successful or fails to authenticate the user 104.

In at least one implementation, the snatch event validator 126 is configured to automatically attempt a biometric authentication by issuing the authentication request 228 in response to the indication of the snatch event 108 (e.g., the snatch event signal 216) being cleared from the memory 220. For example, multiples indications of the snatch event signal 216 are received from the snatch event detector 124. Each snatch event signal 216 is buffered in the memory 220 to allow the snatch event validator 126 to control the timing of when each snatch event signal 216 is processed. Each snatch event signal 216 is processed by first clearing that snatch event signal from the memory 220 to either forward the snatch event signal 216 to the user access control 120 or discard and ignore that snatch event signal 216.

Utilizing the memory 220 to defer or delay processing the snatch event signal 216 enables the snatch event validator 126 to prevent sensor data conflicts between the sensor-based activity 118 and the snatch event detector 124. For example, when the activity state 210 received from the application framework 208 indicates the sensor-based activity 118 is executing, a snatch event flag is set in the memory 220 based on the snatch event signal 216. The snatch event flag may be set in the memory 220 when the sensor-based activity 118 is performing operations using the sensor data 112 directly. In other examples, the snatch event flag is set in the memory 220 when the sensor-based activity 118 follows an execution path triggered by the sensor data 112 being processed and analyzed by a different application or system sensor-based activity. When the activity state 210 indicates the sensor-based activity 118 is not executing and is stopped or paused, then the snatch event validator 126 clears the snatch event flag in the memory 220 and attempts a biometric authentication to verify that the snatch event 108 actually occurred. The snatch event validator 126 allows other sensor-based activities that have potential to induce user inputs, which cause the sensor data 112 to have similar patterns as snatch events to continue executing without being interrupted by an unnecessary device lock.

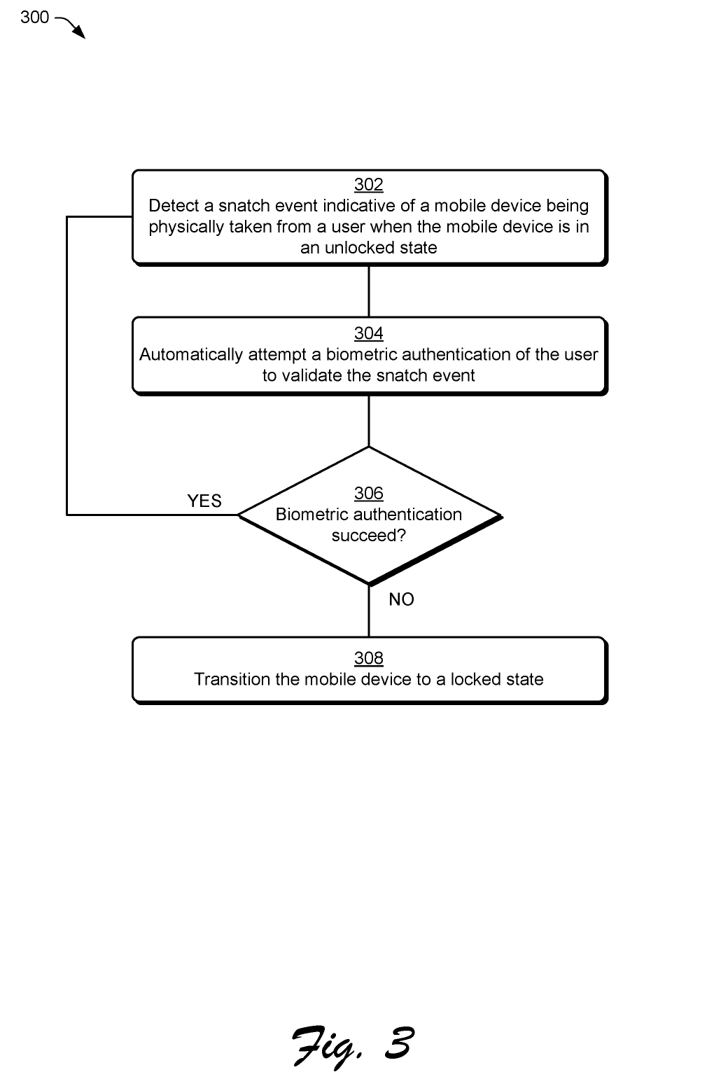

FIG. 3 illustrates a flow chart depicting an example method 300 for mobile device snatch detection and security in accordance with one or more implementations. Operations of the method 300, for instance, may be performed in the context of the environment 100, such as by the mobile device 102 and/or the system 200.

At operation 302, a snatch event indicative of the mobile device being physically taken from a user is detected when the mobile device is in an unlocked state. For example, the snatch event detector 124 outputs the snatch event signal 216 in response to detecting a change in the sensor data 112 that corresponds to a change in the sensor data 112 typically observed when snatch events occur.

Next, at operation 304, a biometric authentication of the user is automatically attempted to validate the snatch event. For example, the snatch event validator 126 causes the biometric authenticator 122 to authenticate the user 104. The biometric authenticator 122 may output the fail / success signal 230 to the snatch event validator 126 as an indication of whether a face authentication, an iris scan authentication, or other biometric authentication is successful or fails to authenticate the user 104.

At operation 306, whether the biometric authentication succeeded is determined. For example, in response to failing to authenticate the user 104, the method 300 continues from the NO path out of the operation 306. In other cases, responsive to a successful biometric authentication, the mobile device 102 is maintained in the unlocked state. For example, responsive to the fail / success signal 230 indicating the biometric authentication is successful, the method 300 follows from the YES path out of the operation 306 by ignoring the snatch event signal 216 and refraining from outputting the snatch event signal 216 to the user access control 120.

At operation 308, the mobile device transitions to a locked state. For example, the snatch event signal 216 is output to the user access control 120, which causes the lock / unlock control 222 transition the mobile device to a locked state.

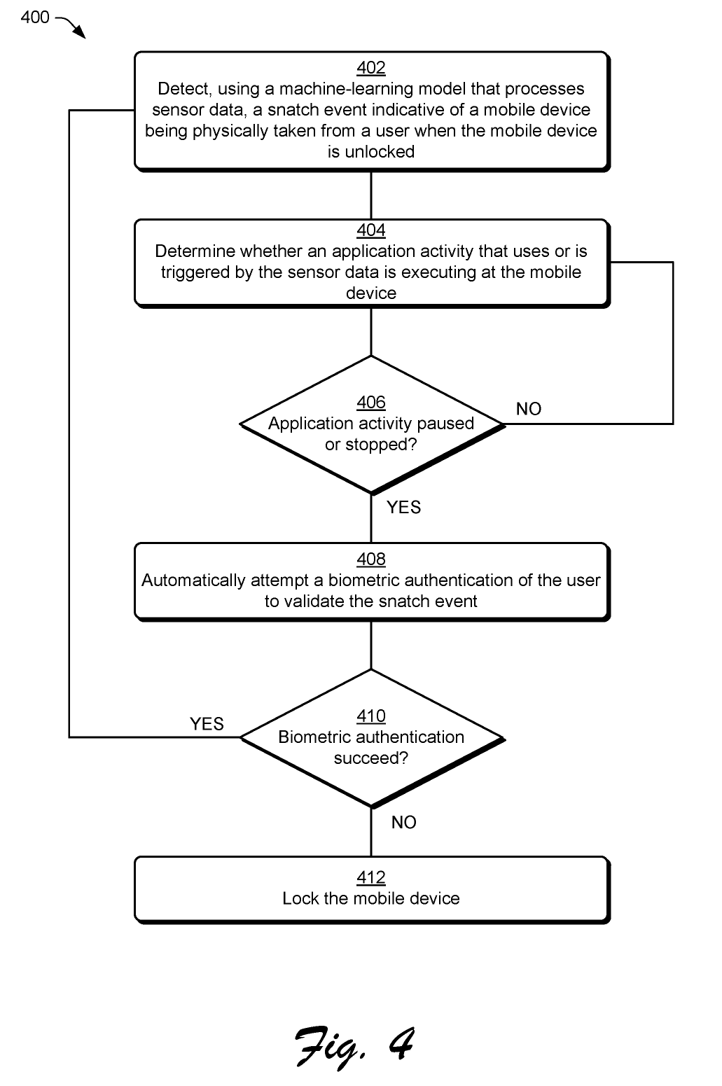

FIG. 4 illustrates a flow chart depicting another example method 400 for mobile device snatch detection and security in accordance with one or more implementations. Operations of the method 400, for instance, may be performed in the context of the environment 100, such as by the mobile device 102 and/or the system 200.

At operation 402, a snatch event indicative of a mobile device being physically taken from a user is detected using a machine-learning model that processes sensor data when the mobile device is unlocked. For example, the machine-learning based detector 212 process the sensor data 112 when the mobile device 102 is unlocked. In response to the snatch event 108 occurring in the environment 100 that causes a sudden change in the sensor data 112, the machine learning based detector 212 outputs the snatch event signal 216.

At operation 404, whether an application activity that uses the sensor data is executing at the mobile device 102 is determined. For example, to avoid interfering with the sensor-based activity 118 executing while the snatch event 108 is being reported, the snatch event validator 126 buffers the snatch event signal 216 in the memory 220 prior to validating whether the snatch event 108 occurred. The snatch event validator 126 may receive the activity state 210 from the application framework 208 indicating the sensor-based activity 118 is performing operations using the sensor data 112 directly or indirectly. For example, the sensor-based activity 118 detects device motion gestures by processing the sensor data 112 directly. In another example, the sensor-based activity 118 is a function executed in response to an output (e.g., a launch command) from a different sensor-based activity that analyzing the sensor data 112 on behalf of the application 116.

At operation 406, whether the application activity is paused or stopped is determined. For example, the activity state 210 indicates the sensor-based activity 118 is a foreground task actively processing the sensor data 112, which causes the method 400 to follow the NO path and return to the operation 404 to continue to monitor the activity state 210 while the sensor-based activity 118 finishes processing the sensor data 112. When the activity state 210 indicates the sensor-based activity 118 is a background task that is stopped or paused, the method 400 continues along the YES path to operation 408. For example, when the sensor-based activity 118 that is triggered by the sensor data 112 or that processes the sensor data 112 is stopped, the method proceeds to the operation 408.

At the operation 408, a biometric authentication of the user is automatically attempted to validate the snatch event. For example, the authentication request 228 is output to the biometric authenticator 122. Based on the authentication request 228, the snatch event validator receives the fail / success signal 230.

At operation 410, whether the biometric authentication succeeded is determined. For example, in response to failing to authenticate the user 104, the method 400 continues from the NO path out of the operation 410. In other cases, responsive to a successful biometric authentication, the mobile device 102 is maintained in the unlocked state. For example, responsive to the fail / success signal 230 indicating the biometric authentication is successful, the method 400 follows from the YES path out of the operation 410 by ignoring the snatch event signal 216 and refraining from outputting the snatch event signal 216 to the user access control 120.

At operation 412, the mobile device is locked. For example, snatch event signal 216 is output to the user access control 120, which causes the lock / unlock control 222 transition the mobile device to a locked state.

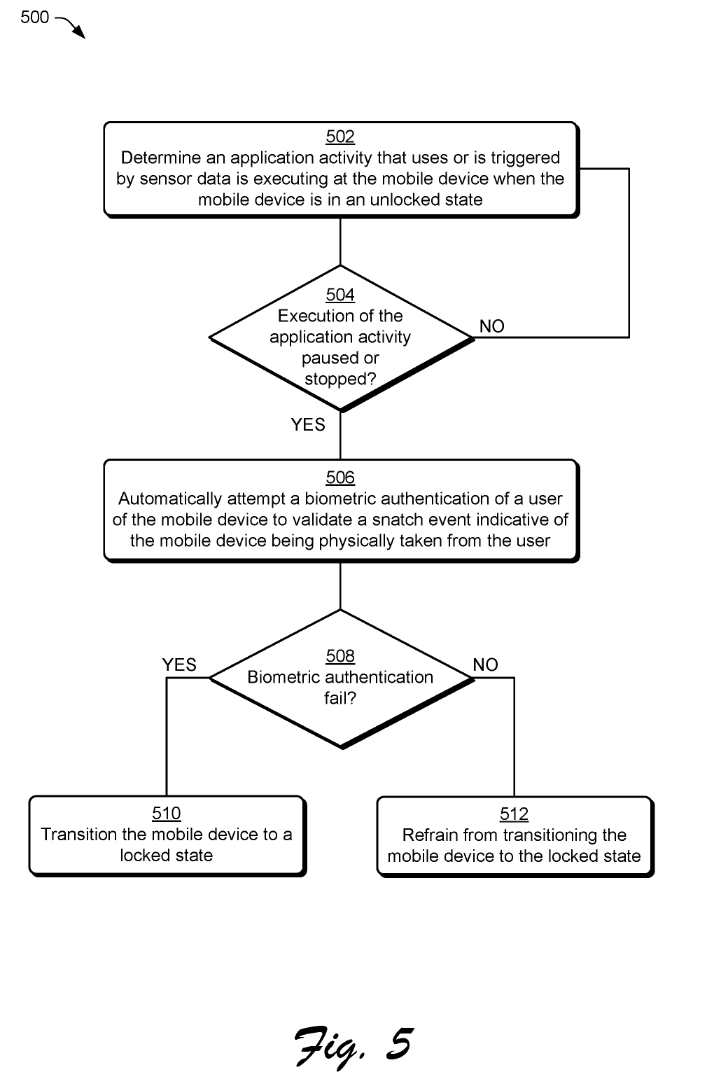

FIG. 5 illustrates a flow chart depicting another example method 500 for mobile device snatch detection and security in accordance with one or more implementations. Operations of the method 500, for instance, may be performed in the context of the environment 100, such as by the mobile device 102 and/or the system 200.

At operation 502, whether an application activity that uses or is triggered by sensor data is executing at the mobile device 102 is determined. For example, the logic based detector 214 process the sensor data 112 when the mobile device 102 is unlocked. In response to the snatch event 108 occurring in the environment 100 that causes a sudden change in the sensor data 112, the logic based detector 214 outputs the snatch event signal 216. To avoid interfering with the sensor-based activity 118 executing while the snatch event 108 is being reported, the snatch event validator 126 buffers the snatch event signal 216 in the memory 220 prior to validating whether the snatch event 108 occurred. For example, based on the activity state 210, the snatch event validator 126 determines whether the sensor-based activity 118, which uses or is triggered by other activities that use the sensor data 112, is executing at the mobile device 102.

At operation 504, whether the application activity is paused or stopped is determined. For example, the activity state 210 indicates the sensor-based activity 118 is processing the sensor data 112 or the sensor-based activity 118, after being triggered indirectly by the sensor data 112, is executing, which causes the method 500 to follow the NO path and return to the operation 502 to continue to monitor the activity state 210. When the activity state 210 indicates the sensor-based activity 118 is stopped or paused, the method 400 continues along the YES path to operation 506.

At the operation 506, a biometric authentication of a user of the mobile device is automatically attempted to validate a snatch event indicative of the mobile device being physically taken from the user. For example, the authentication request 228 is output to the biometric authenticator 122. Based on the authentication request 228, the snatch event validator receives the fail / success signal 230 as a result of the face authentication, the iris scan authentication, or other type of biometric authentication performed by the biometric authenticator 122.

At operation 508, whether the biometric authentication failed is determined. For example, in response to failing to authenticate the user 104, the method 500 continues from the YES path out of the operation 508. In other cases, responsive to a successful biometric authentication, the method 500 continues from the NO path out of the operation 508. As one example, responsive to the fail / success signal 230 indicating the biometric authentication failed, the method 500 proceeds to operation 510, and in alternate cases, the method 500 proceeds to operation 512.

At operation 510, the mobile device transitions to a locked state. For example, snatch event signal 216 is output to the user access control 120, which causes the lock / unlock control 222 lock the mobile device 102 and prevent access.

At operation 512, the mobile device refrains from transitioning to the locked state. For example, the snatch event validator 126 causes the system 200 to ignore the snatch event signal 216 and continue operating in the unlocked state.

The example methods described above may be performed in various ways, such as for implementing different aspects of the systems and scenarios described herein. Any services, components, modules, methods, and/or operations described herein can be implemented using software, firmware, hardware (e.g., fixed logic circuitry), manual processing, or any combination thereof. Some operations of the example methods may be described in the context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 6 illustrates various components of an example device in which aspects of mobile device snatch detection and security can be implemented in accordance with one or more implementations. The device 600 can be implemented as any of the devices described with reference to the previous FIGS. 1-5, such as any type of mobile device, mobile phone, wearable device, tablet, computing device, communication device, entertainment device, gaming device, media playback device, and/or other type of electronic device. For example, aspects of the mobile device 102 and/or the system 200, as shown and described with reference to FIGS. 1-5 may be implemented as the example device 600.

The device 600 includes communication transceivers 602 that enable wired and/or wireless communication of device data 604 with other devices. The device data 604 can include any of device identifying data, device location data, wireless connectivity data, and wireless protocol data. Additionally, the device data 604 can include any type of audio, video, and/or image data. The device data 604 can include any type of communication data, such as radio measurements and radio messages. Example communication transceivers 602 include wireless personal area network (WPAN) radios compliant with various IEEE 802.15 (Bluetooth^{TM}) standards, wireless local area network (WLAN) radios compliant with any of the various IEEE 802.10 (Wi-Fi^{TM}) standards, wireless wide area network (WWAN) radios for cellular phone communication, wireless metropolitan area network (WMAN) radios compliant with various IEEE 802.16 (WiMAX^{TM}) standards, and wired local area network (LAN) Ethernet transceivers for network data communication.

The device 600 may also include one or more data input ports 606 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 600 includes a processing system 608 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits 610. The device 600 may further include any type of a system bus or other data and command transfer system that couples the various components within the device. A system bus can include any one or combination of different bus structures and architectures, as well as control and data lines.

The device 600 also includes computer-readable storage memory 612 (e.g., memory devices) that enable data storage, such as data storage devices that can be accessed by a computing device, and that provide persistent storage of data and executable instructions (e.g., software applications, programs, functions, and the like). Examples of the computer-readable storage memory 612 include volatile memory and non-volatile memory, fixed and removable media devices, and any suitable memory device or electronic data storage that maintains data for computing device access. The computer-readable storage memory 612 can include various implementations of random access memory (RAM), read-only memory (ROM), flash memory, and other types of storage media in various memory device configurations. The device 600 may also include a mass storage media device. Computer-readable storage memory 612 represents media and/or devices that enable persistent and/or non-transitory storage of information in contrast to mere signal transmission, carrier waves, or signals per se. Computer-readable storage memory 612 do not include signals per se or transitory signals. The memory 114 and the memory 220 are examples of the computer-readable storage memory 612.

The computer-readable storage memory 612 provides data storage mechanisms to store the device data 604, other types of information and/or data, and various device applications 614 (e.g., software applications). The device applications 614 include the application 116, including the sensor-based activity 118, for instance. As another example of device programs maintained in the computer-readable storage memory 612 include instructions for an operating system 616. The operating system 612, for example, implements one or more of the user access control 120, the biometric authenticator 122, the snatch event detector 124, and the snatch event validator 126. The instructions can be maintained as software instructions within the memory 612 and executed by the processing system 608. The device applications 614 may also include a device manager, such as any form of a control application, software application, signal-processing and control module, code that is native to a particular device, a hardware abstraction layer for a particular device, and so on.

In this example, the example device 600 also includes a camera 618 and motion sensors 620, such as may be implemented in an inertial measurement unit (IMU). The motion sensors 620 can be implemented with various sensors, such as the sensors 110, for example, including a gyroscope, an accelerometer, and/or other types of motion sensors to sense motion of the device. The various motion sensors 620 may also be implemented as components of an inertial measurement unit in the device. The device 600 also includes a wireless module 622, which is representative of functionality to perform various wireless communication tasks, such as through a remote service accessed from a network connection established by the wireless module 622 to a network.

The device 600 can also include one or more power sources 624, such as when the device is implemented as a mobile device. The power sources 624 may include a charging and/or power system, and can be implemented as a flexible strip battery, a rechargeable battery, a charged super-capacitor, and/or any other type of active or passive power source.

The device 600 also includes an audio and/or video processing system 626 that generates audio data for an audio system 628 and/or generates display data for a display system 630. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 632. In implementations, the audio system and/or the display system are integrated components of the example device. Alternatively, the audio system and/or the display system are external, peripheral components to the example device.

Although implementations of mobile device snatch detection and security have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described, and it is to be appreciated that each described example can be implemented independently or in connection with one or more other described examples. Additional aspects of the techniques, features, and/or methods discussed herein relate to one or more of the following:

In some aspects, the techniques described herein relate to a mobile device, including: at least one memory; and at least one processor coupled with the at least one memory and configured to cause the mobile device to: detect a snatch event indicative of the mobile device being physically taken from a user when the mobile device is in an unlocked state; automatically attempt a biometric authentication of the user to validate the snatch event; responsive to a failed biometric authentication, transition the mobile device to a locked state; and responsive to a successful biometric authentication, maintain the mobile device in the unlocked state.

In some aspects, the techniques described herein relate to a mobile device, wherein the biometric authentication includes a face authentication.

In some aspects, the techniques described herein relate to a mobile device, wherein the biometric authentication includes an iris scan authentication.

In some aspects, the techniques described herein relate to a mobile device, wherein the snatch event is detected by a machine-learning model trained to detect the snatch event based on sensor data collected by one or more sensors of the mobile device.

In some aspects, the techniques described herein relate to a mobile device, wherein the snatch event is detected in response to identifying a change in sensor data collected by one or more sensors of the mobile device that satisfies a threshold for suspected snatch events.

In some aspects, the techniques described herein relate to a mobile device, wherein the sensor data includes accelerometer data and the threshold for suspected snatch events corresponds to a change in acceleration of the mobile device.

In some aspects, the techniques described herein relate to a mobile device, wherein the sensor data includes gyroscope data and the threshold for suspected snatch events corresponds to a change in a rate of rotation of the mobile device.

In some aspects, the techniques described herein relate to a mobile device, wherein the sensor data includes barometer data and the threshold for suspected snatch events corresponds to a change in an elevation of the mobile device based on ambient air pressure measurements included in the barometer data.

In some aspects, the techniques described herein relate to a mobile device, wherein the threshold for suspected snatch events is different than at least one other threshold that is used to detect at least one of a drop event, a fall event, or a user gesture event.

In some aspects, the techniques described herein relate to a system including: at least one memory; and at least one processor coupled with the at least one memory and configured to cause the system to: detect, using a machine-learning model that processes sensor data collected by one or more sensors, a snatch event indicative of the system being physically taken from a user when the system is in an unlocked state; determine whether an application activity that uses or is triggered by the sensor data is executing at the at least one processor; automatically attempt a biometric authentication of the user to validate the snatch event when execution of the application activity is stopped or paused; and responsive to a failed biometric authentication, transition the system to a locked state.

In some aspects, the techniques described herein relate to a system, wherein the at least one processor is further configured to maintain the system in the unlocked state in response to a successful biometric authentication.

In some aspects, the techniques described herein relate to a system, wherein the biometric authentication includes at least one of a face authentication or an iris scan authentication.

In some aspects, the techniques described herein relate to a system, wherein the sensor data includes one or more of accelerometer data, gyroscope data, and barometer data.

In some aspects, the techniques described herein relate to a system, wherein the application activity uses the sensor data is configured to respond to user gesture events inferred from the sensor data, wherein the user gesture events comprises at least one of a device shake gesture, a device chop gesture, a device twist gesture, a device lift gesture, or a device flip gesture.

In some aspects, the techniques described herein relate to a system, wherein the application activity is triggered by the sensor data in response to another application or system service outputting an indication of a user gesture event inferred from the sensor data.

In some aspects, the techniques described herein relate to a system, wherein an indication of the snatch event is flagged in the at least one memory when the application activity is executing, and the indication of the snatch event is cleared from the at least one memory when the application activity is stopped or paused.

In some aspects, the techniques described herein relate to a system, wherein the biometric authentication is automatically attempted in response to the indication of the snatch event being cleared from the at least one memory.

In some aspects, the techniques described herein relate to a method performed by a mobile device, the method including: determining an application activity that uses or is triggered by sensor data is executing at the mobile device when the mobile device is in an unlocked state; responsive to determining execution of the application activity is stopped or paused, automatically attempting a biometric authentication of a user of the mobile device to validate a snatch event indicative of the mobile device being physically taken from the user; and responsive to a failed biometric authentication, transition the mobile device to a locked state.

In some aspects, the techniques described herein relate to a method, further including detecting the snatch event based on the sensor data using a machine-learning model.

In some aspects, the techniques described herein relate to a method, further including: determining a second application activity that uses or is triggered by the sensor data is executing at the mobile device when the mobile device is in the unlocked state; responsive to determining execution of the second application activity is stopped or paused, automatically attempting the biometric authentication of the user to validate a second snatch event indicative of the mobile device being physically taken from the user; and responsive to a successful biometric authentication, refraining from transitioning the mobile device to the locked state.

1. A mobile device, comprising:
at least one memory; and
at least one processor coupled with the at least one memory and configured to cause the mobile device to:
detect a snatch event indicative of the mobile device being physically taken from a user when the mobile device is in an unlocked state;
automatically attempt a biometric authentication of the user to validate the snatch event;
responsive to a failed biometric authentication, transition the mobile device to a locked state; and
responsive to a successful biometric authentication, maintain the mobile device in the unlocked state.

2. The mobile device of claim 1, wherein the biometric authentication includes a face authentication.

3. The mobile device of claim 1, wherein the biometric authentication includes an iris scan authentication.

4. The mobile device of claim 1, wherein the snatch event is detected by a machine-learning model trained to detect the snatch event based on sensor data collected by one or more sensors of the mobile device.

5. The mobile device of claim 1, wherein the snatch event is detected in response to identifying a change in sensor data collected by one or more sensors of the mobile device that satisfies a threshold for suspected snatch events.

6. The mobile device of claim 5, wherein the sensor data comprises accelerometer data and the threshold for suspected snatch events corresponds to a change in acceleration of the mobile device.

7. The mobile device of claim 5, wherein the sensor data comprises gyroscope data and the threshold for suspected snatch events corresponds to a change in a rate of rotation of the mobile device.

8. The mobile device of claim 5, wherein the sensor data comprises barometer data and the threshold for suspected snatch events corresponds to a change in an elevation of the mobile device based on ambient air pressure measurements included in the barometer data.

9. The mobile device of claim 5, wherein the threshold for suspected snatch events is different than at least one other threshold that is used to detect at least one of a drop event, a fall event, or a user gesture event.

10. A system comprising:
at least one memory; and
at least one processor coupled with the at least one memory and configured to cause the system to:
detect, using a machine-learning model that processes sensor data collected by one or more sensors, a snatch event indicative of the system being physically taken from a user when the system is in an unlocked state;
determine whether an application activity that uses or is triggered by the sensor data is executing at the at least one processor;
automatically attempt a biometric authentication of the user to validate the snatch event when execution of the application activity is stopped or paused; and
responsive to a failed biometric authentication, transition the system to a locked state.

11. The system of claim 10, wherein the at least one processor is further configured to maintain the system in the unlocked state in response to a successful biometric authentication.

12. The system of claim 10, wherein the biometric authentication includes at least one of a face authentication or an iris scan authentication.

13. The system of claim 10, wherein the sensor data comprises one or more of accelerometer data, gyroscope data, and barometer data.

14. The system of claim 10, wherein the application activity uses the sensor data is configured to respond to user gesture events inferred from the sensor data, wherein the user gesture events comprises at least one of a device shake gesture, a device chop gesture, a device twist gesture, a device lift gesture, or a device flip gesture.

15. The system of claim 10, wherein the application activity is triggered by the sensor data in response to another application or system service outputting an indication of a user gesture event inferred from the sensor data.

16. The system of claim 10, wherein an indication of the snatch event is flagged in the at least one memory when the application activity is executing, and the indication of the snatch event is cleared from the at least one memory when the application activity is stopped or paused.

17. The system of claim 16, wherein the biometric authentication is automatically attempted in response to the indication of the snatch event being cleared from the at least one memory.

18. A method performed by a mobile device, the method comprising:
determining an application activity that uses or is triggered by sensor data is executing at the mobile device when the mobile device is in an unlocked state;
responsive to determining execution of the application activity is stopped or paused, automatically attempting a biometric authentication of a user of the mobile device to validate a snatch event indicative of the mobile device being physically taken from the user; and
responsive to a failed biometric authentication, transition the mobile device to a locked state.

19. The method of claim 18, further comprising detecting the snatch event based on the sensor data using a machine-learning model.

20. The method of claim 18, further comprising:
determining a second application activity that uses or is triggered by the sensor data is executing at the mobile device when the mobile device is in the unlocked state;
responsive to determining execution of the second application activity is stopped or paused, automatically attempting the biometric authentication of the user to validate a second snatch event indicative of the mobile device being physically taken from the user; and
responsive to a successful biometric authentication, refraining from transitioning the mobile device to the locked state.
